(19) United States
(12) Patent Application Publication
(10) Pub. No.: US 2003/0222485 A1
(43) Pub. Date: Dec. 4, 2003

(54) Convertible articulated support structure for cradle or ottoman

(76) Inventor: Neil J. Dwyer, Parma, OH (US)

Correspondence Address: JAMES C. SCOTT, ESQ., ROETZEL & ANDRESS, 1375 E. 9TH STREET, ONE CLEVELAND CENTER, 10TH FLOOR, CLEVELAND, OH, 44114, US

(21) Appl. No.: 10/161,365

(22) Filed: Jun. 3, 2002

(51) Int. Cl. B60N 2/32

(52) U.S. Cl. 297/118

(57) ABSTRACT

A convertible articulated support structure for cradle or ottoman has a base with an oscillating support structure attached to a mounting platform for removable attachment of a cradle or ottoman cushion. The articulated support structure moves in an oscillatory path relative to the stationary base, carrying the selected attachment through a gentle reciprocating motion. Removable fasteners enable easy exchange of the cradle attachment with a cushion attachment.

### FIELD OF THE INVENTION

The present invention pertains generally to furniture and, more particularly, to furniture with moving parts and interchangeable components for conversion between alternate configurations for different uses.

### BACKGROUND OF THE INVENTION

There are a wide variety of cradles for infants and children. A typical cradle consists of a frame connected to a pair of rocker mounts with rounded bottom surfaces for rocking motion of the cradle. The arcuate shape of the rocker contact surfaces imparts a circular and rolling motion to the baby in the cradle, which is suitable only at very low speed and displacement. The same is true with respect to cradles which are pivotally mounted on a horizontally disposed axis, as shown for example in one form in U.S. Pat. No. 3,648,307. Also, the utility of a traditional rockertype cradle is limited to the short infant stage of life, after which a crib is used.

Thus, a cradle device which provides a more desirable rocking action with less rolling motion imparted to the occupant, and which has increased utility and adaptability to other uses would be desirable. U.S. Pat. No. 4,615,059 discloses a crib or cradle supported by a stationary support structure and an articulated dowel and strap assembly which produces gentle side-to-side motion. The cradle portion, however, is integrally and permanently attached to the articulated support structure, such that the entire structure is dedicated to the single function and purpose of providing a motion cradle.

The prior art also includes glider rockers in which a chair is pivotally supported by swinging members which are suspended at pivot points. The resulting motion of the chair is primarily fore and aft, with a slight rise and fall through the small arc of the swinging pivot members. This articulated gliding motion has also been incorporated in an ottoman or foot stool, which has a permanently attached cushion top as a supporting surface.

The prior art does not include the combination of articulated motion type furniture with convertible components for alternate uses or applications.

### SUMMARY OF THE PRESENT INVENTION

The present invention provides a convertible articulated cradle and ottoman which enhances the usefulness of traditional cradles by enabling a cradle or bassinet with oscillating lateral motion, and providing for conversion to an oscillating ottoman. When the oscillating cradle embodiment is used, the articulated base structure allows for the smooth and quiet primarily lateral rocking of a cradle attached to an articulated support structure. The cradle can be easily removed from the support structure and an ottoman cushion attached in place thereof. The oscillating ottoman can be used as a separate piece or in combination with a chair, rocker or gliding rocker.

In accordance with one general aspect of the invention, there is provided a convertible articulated support structure for a cradle or ottoman which has a stationary base or stand with an articulated support structure attached by a pivoted linkage to the stand. The support structure is linked to move in an oscillating path relative to the stand. Additionally, the support structure includes a mounting platform configured for attachment to the bottom of a cradle. The cradle is removably secured to the mounting platform of the support structure by at least one fastener for easy exchange with an ottoman cushion.

In accordance with another aspect of the invention, there is provided a convertible articulated support structure including, in combination a base having a stationary stand and an articulated support structure attached to the stand and having a mounting platform, the articulated support structure configured to impart an oscillating motion to the mounting platform relative to the stand; the mounting platform configured for attachment of a cradle by at least one removable fastener, whereby the cradle can be attached to and detached from the mounting platform; and an ottoman cushion having a mounting surface configured for attachment to the mounting platform in place of the cradle by at least one removable fastener.

These and other aspects of the present invention are herein described in further detail, with reference to the accompanying Figures, the illustrated embodiments being representative of only some of they ways in which the principles and concepts of the invention can be executed and employed.

Additional objects, advantages and novel features of the invention are set forth in the following description, and will be apparent to those skilled in the art upon examination of the following or may be learned by practice of the invention. The objects and advantages of the invention may be realized and attained by various structures as covered by the patent claims.

### DESCRIPTION OF THE FIGURES

In the accompanying Figures:

FIG. 1 is a perspective view of the cradle/ottoman combination of the present invention, showing the cradle frame attached to an articulated base;

FIG. 2 is a perspective exploded view of the cradle/ottoman combination of the present invention; and

FIG. 3 is an elevation view of the cradle/ottoman of the present invention, showing the cradle frame attached to the base.

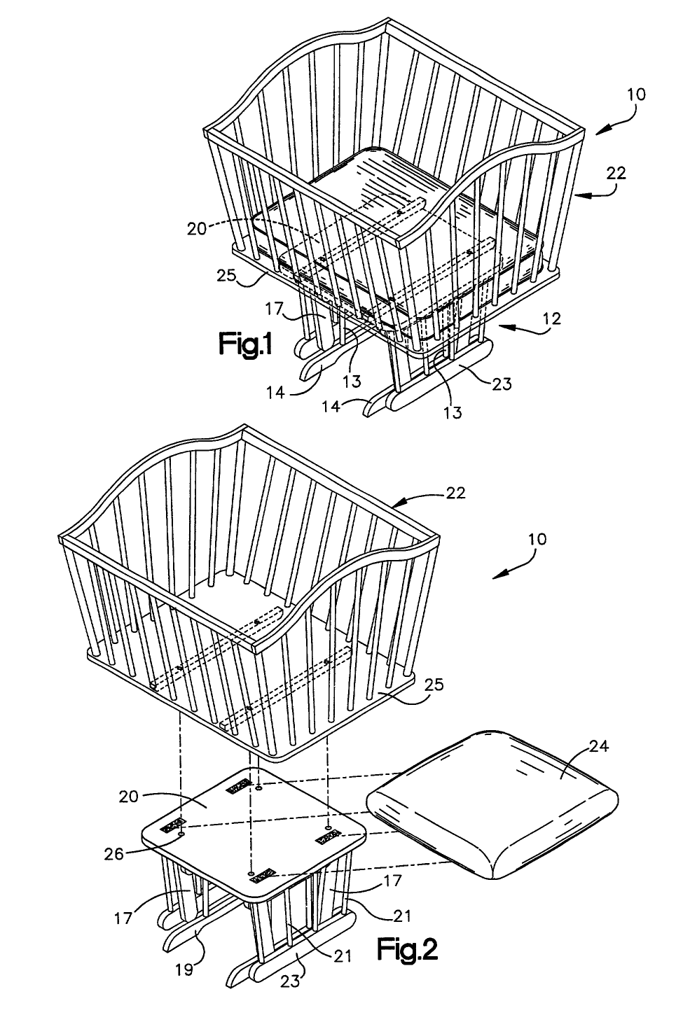

### DETAILED DESCRIPTION OF PREFERRED AND ALTERNATE EMBODIMENTS

With reference to the Figures, there is shown a convertible articulated support structure for a cradle or ottoman, indicated generally at 10, which includes a base 12 with stand pieces 14 configured for floor mounting. The base 12 includes an articulated support structure configured for oscillatory motion relative to the stationary stand pieces 14, and supports either a cradle 22 or ottoman type structure or foot stool cushion 24, as further described. Extending vertically upward from a top edge of each of the stand pieces 14 are pillars 13. The upper distal ends of each pillar 13 are attached to and support a corresponding horizontally disposed cross beam 15 directly above the corresponding stand piece 14. Pivotally suspended from each of end of each cross beam 15 is a sway bar 17, attached to the cross beam at pivot points 171. The lower ends of the sway bars are similarly pivotally attached at pivot points 231 to oscillating beams 23, which are attached by riser members 21 to a base mounting platform 20. The base mounting platform 20 provides a horizontal mounting surface of the articulated support structure for attachment of either a cradle 22 or ottoman cushion 24 (referred to herein alternatively as “attachments”), to thereby impart oscillatory motion to the chosen attachment.

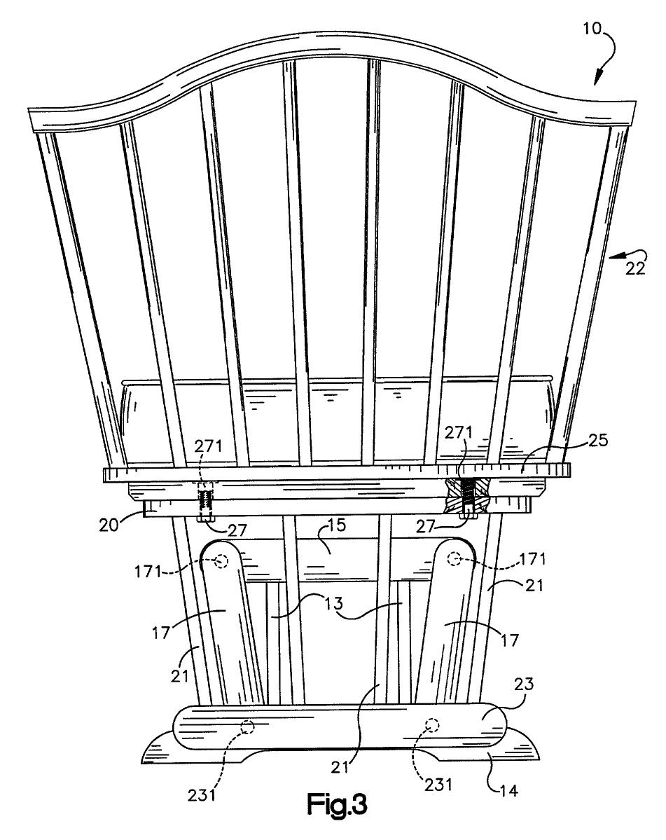

As shown in FIG. 2, the cradle 22 has a bottom 25 which is removably attached to the mounting platform 20 of the base 12, such that it can be removed and replaced with an ottoman cushion 24. Although referred to herein as a “cradle”, the cradle structure 22 may be in any particular form, size or shape, the primary physical characteristic being a support structure for containing an infant/small child. Additionally, the ottoman cushion 24 may also be in any particular form, size or shape, the primary physical characteristic being a pillow-like support structure with a generally planar mounting surface for attachment to the generally planar mounting platform 20.

The cradle 22 or ottoman cushion 24 are removably securable directly to the base mounting platform 20 of the base 12 by at least one fastener. In one embodiment, four bolts 27 are located through the cradle bottom 25 for insertion into through-holes in the base mounting platform 20, as best shown in FIG. 3. Nuts 271, which in this embodiment are preferably wingnuts or other easily manipulated fastenable and releasable device, are then removably fastened to the ends of the bolts 27, thereby securing the cradle 22 to the base mounting platform to move with the articulated oscillating motion of the base 12. The cradle bottom 25 is preferably dimensioned so that a width generally corresponds with a width of the mounting platform 20 of the articulated support structure, so that the cradle 22 is oriented with a width dimension aligned with the direction of oscillating motion of the articulated support structure. The cradle bottom 25 may also be configured with one or more guides which interact with edges of the mounting platform 20 both for proper registration and alignment of the cradle and the fasteners with the through-holes, and to provide a more secure attachment of the cradle to the support structure.

The ottoman cushion 24 is preferably constructed with a planar underside surface also having four fasteners aligned with fastener through-holes in the mounting platform 20 of the base 12. Similar to the cradle bottom, the mounting surface of the cushion 24 may further include rails or edges for registration and alignment with the mounting platform 20 of the base 12. The use of nuts and bolts to removably secure the structures together is only an example, any other suitable means for fastening the cradle frame 22 and/or ottoman cushion 24 to the frame 20 can by used, i.e. such as metal brackets, or wood pegs with corresponding holes and other types of disengageable fastening devices. In one particular alternate embodiment, a binding fabric interface such as Velcro™ is used at the interface between the bottom of the ottoman cushion and the mounting platform. Similar type fastening devices may be used in connection with the cradle depending upon the required fastening force adequate for safe operation.

The rocking movement generated is very gentle, oscillating the cradle in a smooth gliding type motion. Throughout this motion, the cradle 22 remains in a generally horizontal plane, which is preferable over rocking movement which puts the cradle bottom at a substantial incline as it rocks side-to-side. This is only one embodiment of other types of articulated support structures which provide the preferred oscillating type gliding motion relative to a stationary stand.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive. Other features and aspects of this invention will be appreciated by those skilled in the art of designing and manufacturing cradles upon reading and comprehending this disclosure. Such features, aspects, and expected variations and modifications of the reported results and examples are clearly within the scope of the invention where the invention is limited solely by the scope of the following claims.

What is claimed as the invention is:

1. A convertible articulated support structure comprising, in combination:
a base having a stationary stand and an articulated support structure attached to the stand and having a mounting platform, the articulated support structure configured to impart an oscillating motion to the mounting platform relative to the stand;
the mounting platform configured for attachment of a cradle by at least one removable fastener, whereby the cradle can be attached to and detached from the mounting platform;
and an ottoman cushion having a mounting surface configured for attachment to the mounting platform in place of the cradle by at least one removable fastener.

2. The convertible articulated support structure of claim 1 wherein the cradle is attached to the mounting platform in place of the ottoman cushion.

3. The convertible articulated support structure of claim 1 wherein the ottoman cushion is attached to the mounting platform in place of the cradle.

4. The convertible articulated support structure of claim 1 having four removable fasteners between the mounting platform and the bottom of the cradle or ottoman cushion.

5. The convertible articulated support structure of claim 4 wherein ends of the fasteners are exposed at an underside of the bottom of the cradle or ottoman cushion and accessible through the support structure.

6. The convertible articulated support structure of claim 1 wherein the mounting platform has an area dimension less than an area dimension of the bottom of the cradle.

7. The convertible articulated support structure of claim 1 wherein the mounting platform has an area dimension less than an area dimension of a bottom of the ottoman cushion.

8. The convertible articulated support structure of claim 1 wherein the cradle is oriented on the support structure with a width dimension generally aligned with a direction of oscillatory displacement of the support structure.

9. The convertible articulated support structure of claim 1 wherein the cradle is oriented on the support structure with a length dimension generally aligned with a direction of oscillatory displacement of the support structure.

10. A convertible articulated support structure in combination with an attachment which is removably attached to a mounting platform of the support structure, the articulated support structure having a stationary stand supporting cross beams to which pivot arms are pivotally attached for pivotal suspension of corresponding oscillating carriage members which are attached by risers to the mounting platform, the mounting platform thus being articulated for oscillating motion relative to the stationary base,
and an attachment removably attached to the mounting platform of the articulated support structure by one or more fasteners.

11. The convertible articulated support structure of claim 10 wherein one of the attachments is a cradle.

12. The convertible articulated support structure of claim 10 wherein one of the attachments is a cushion.

13. The convertible articulated support structure of claim 10 wherein the attachment is oriented relative to the support structure so that the oscillating motion is in a direction parallel to a width dimension of the attachment.

14. The convertible articulated support structure of claim 10 wherein the attachment is oriented relative to the support structure so that the oscillating motion is in a direction parallel to a length dimension of the attachment.

15. An articulated support structure adaptable for attachment of a cradle or ottoman cushion to a mounting platform of the support structure, and at least one disengageable fastener at an interface of the cradle or ottoman cushion with the mounting platform of the articulated support structure.

16. An articulated cradle assembly comprising:
a base having a stationary stand and an articulated support structure attached to the stand and having a mounting platform, the articulated support structure configured to impart an oscillating motion to the mounting platform relative to the stand, and
a cradle attached to the mounting platform of the support structure.

17. The articulated cradle assembly of claim 16 wherein the articulated support structure of the base has a stationary stand supporting cross beams to which pivot arms are pivotally attached for pivotal suspension of corresponding oscillating carriage members which are attached by risers to the mounting platform.

18. The articulated cradle assembly of claim 16 wherein the cradle is oriented relative to the base so that the oscillating motion is in a direction parallel to a width of the cradle.

19. The articulated cradle assembly of claim 16 wherein the cradle is oriented relative to the base so that the oscillating motion is in a direction parallel to a length of the cradle.
